(19) United States
(12) Patent Application Publication
(10) Pub. No.: US 2006/0293896 A1
(43) Pub. Date: Dec. 28, 2006

(54) User interface apparatus and method

(76) Inventor: Kenichiro Nakagawa, Kawasaki-shi (JP)

Correspondence Address: MORGAN & FINNEGAN, L.L.P., 3 WORLD FINANCIAL CENTER, NEW YORK, NY, 10281-2101, US

(21) Appl. No.: 11/477,342

(22) Filed: Jun. 28, 2006

(30) Foreign Application Priority Data
Jun. 28, 2005 (JP) 2005-188317

(51) Int. Cl. G10L 21/00

(52) U.S. Cl. 704/270

(57) ABSTRACT

A user interface control method for controlling a user interface capable of setting contents of plural setting items using a speech. An input speech is subjected to speech recognition processing, and a speech recognition result is obtained. Further, setup data indicating the content of already-set setting item is obtained from a memory. The recognition result obtained by the speech recognition is merged with the setup data obtained from the memory, thereby merged data is generated. The merged data is outputted for a user's recognition result determination operation. Then, the setup data is updated in correspondence with the recognition result determination operation.

### FIELD OF THE INVENTION

The present invention relates to a user interface utilizing speech recognition processing.

### BACKGROUND OF THE INVENTION

Speech is a natural interface for humans, and it is accepted as an effective user interface (UI) for device-inexperienced users such as children, elder people and visually impaired people. In recent years, a data input method using a combination of speech UI and graphical user interface (GUI) attracts attention, and there is much debate about the method in “W3C Multimodal Interaction Activity (http://www.w3.org/2002/mmi/)” and “SALT Forum (http://www.saltforum.org/)”.

Data input by speech is generally performed using well-known speech recognition processing. The speech recognition processing compares an input speech with recognition subject vocabulary described in speech recognition grammars, and outputs vocabulary with the highest matching level as a recognition result. The recognition result of the speech recognition processing is presented to a user for the user's checking and determination operation (selection from recognition result candidates). The presentation of speech recognition results to the user is generally made using text information or speech output, and further, the presentation may be made using an icon or image. Japanese Patent Application Laid-Open No. 9-206329 discloses an example where a sign language mark is presented as a speech recognition result. Further, Japanese Patent Application Laid-Open No. 10-286237 discloses an example of home medical care apparatus which presents a recognition result using a speech or image information. Further, Japanese Patent Application Laid-Open No. 2002-140190 discloses a technique of converting a recognition result into an image or characters and displaying the converted result in a position designated with a pointing device.

According to the above constructions, as the content of speech input (recognition result) is presented using an image, the user intuitively checks the recognition result, and the operability is improved. However, generally, the presentation of speech recognition result is made for checking and/or determining the recognition result, and only the speech recognition result as the subject of checking/determination is presented. Accordingly, the following problem occurs.

For example, when a copier is provided with a speech dialog function, a dialog between the user and the copier can be considered as follows. Note that in the dialog, “S” means a speech output from the system (copier), and “U”, the user's speech input.

S1: “Ready for setup of Copy setting. Please say a desired setting value. When setting is completed, press start key.”

U2: “Double-sided output”

S3: “Double-sided output. Is that correct?”

U4: “Yes”

S5: “Please say a setting value if you would like to make another setting. When setting is completed, press start key.”

U6: “A4 paper”

S7: “A4 paper is to be used?”

U8: “Yes”

In the above example, the speech S3 and S7 are presentations for the user's checking the recognition result, and the speech U4 and U8 are the user's determination instruction.

In a case where the copier to perform such dialog has a device to display a GUI (for example, a touch panel), it is desirable to assist the system speech output using the GUI as described above. For example, assuming that image information is generated from the speech recognition result or an image corresponding to the speech recognition result is selected and presented to the user utilizing the techniques of the above-described prior art (Application Laid-Open Nos. 9-206329, 10-286237 and 2002-140190), in the status of the speech S3, a GUI screen like a screen 701 in FIG. 7 can be presented, and in the status of the speech S7, a GUI screen like a screen 702 in FIG. 7 can be presented. The user can intuitively check the content of utterance by the user with the displayed image information. This is very effective in that the clarity of dialog can be improved.

However, users have an inclination to misconstrue such image presentation of recognition result as a final finished image. For example, in the screen 702 in FIG. 7, the content of previously setting, “double-sided output”, is not reflected at all. Accordingly, when this image (702) is presented in the status of the speech S7, the user may misunderstand that the previous setting (double-sided output) has been cleared and say “double-sided output” again. In the above-described prior art, this problem is not solved.

### SUMMARY OF THE INVENTION

The present invention has been made in consideration of the above problem, and has its object to provide a user interface with excellent operability which prevents a user's misconstruction of the presentation of speech recognition result.

According to one aspect of the present invention, there is provided a user interface control method for controlling a user interface capable of setting contents of plural setting items using a speech, comprising: a speech recognition step of performing speech recognition processing on an input speech; an acquisition step of acquiring setup data indicating the content of already-set setting item from a memory; a merge step of merging a recognition result obtained at the speech recognition step with the setup data acquired at the acquisition step thereby generating merged data; an output step of outputting the merged data for a user's recognition result determination operation; and an update step of updating the setup data in correspondence with the recognition result determination operation.

Other features and advantages of the present invention will be apparent from the following description taken in conjunction with the accompanying drawings, in which like reference characters designate the same name or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1A is a block diagram showing the schematic construction of a copier having a speech recognition device according to a first embodiment of the present invention;

FIG. 1B is a block diagram showing the functional construction of the speech recognition device according to the embodiment;

FIG. 2 is a flowchart showing processing by the speech recognition device according to the embodiment;

FIG. 3 is a table showing a data structure of a setup database used by the speech recognition device according to the embodiment;

FIG. 4 illustrates a display example of a speech recognition result check screen by the copier having the speech recognition device according to the embodiment;

FIG. 5A illustrates an example of GUI screen of the copier according to a second embodiment of the present invention;

FIG. 5B illustrates an example of GUI screen of the copier according to a third embodiment of the present invention;

FIG. 6 illustrates an example of GUI screen of the copier according to a fourth embodiment of the present invention; and

FIG. 7 illustrates an example of general GUI screen when a speech recognition result is represented as an image.

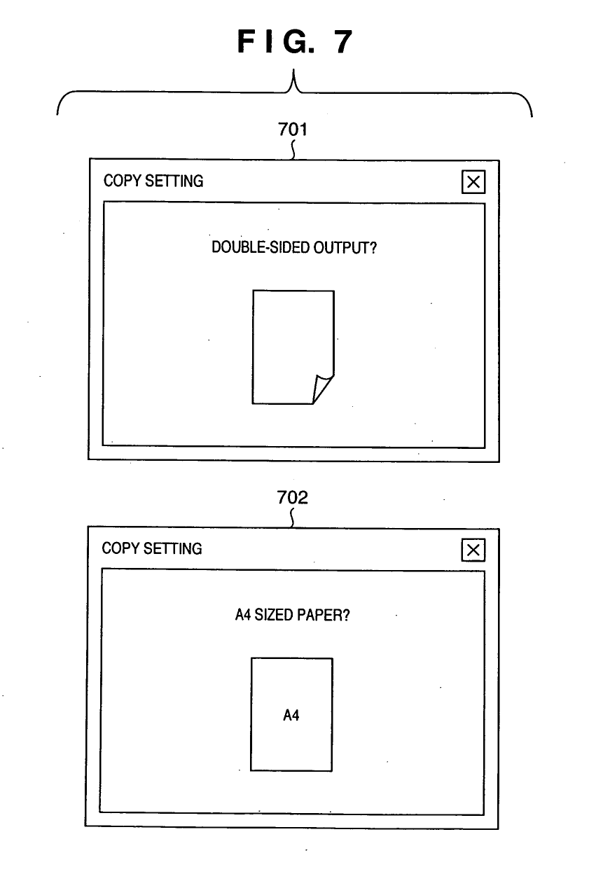

### DETAILED DESCRIPTION OF THE PREFERRED EMBODIMENTS

Preferred embodiments of the present invention will now be described in detail in accordance with the accompanying drawings.

Note that in the respective embodiments, the present invention is applied to a copier, however, the application of the present invention is not limited to the copier.

### First Embodiment

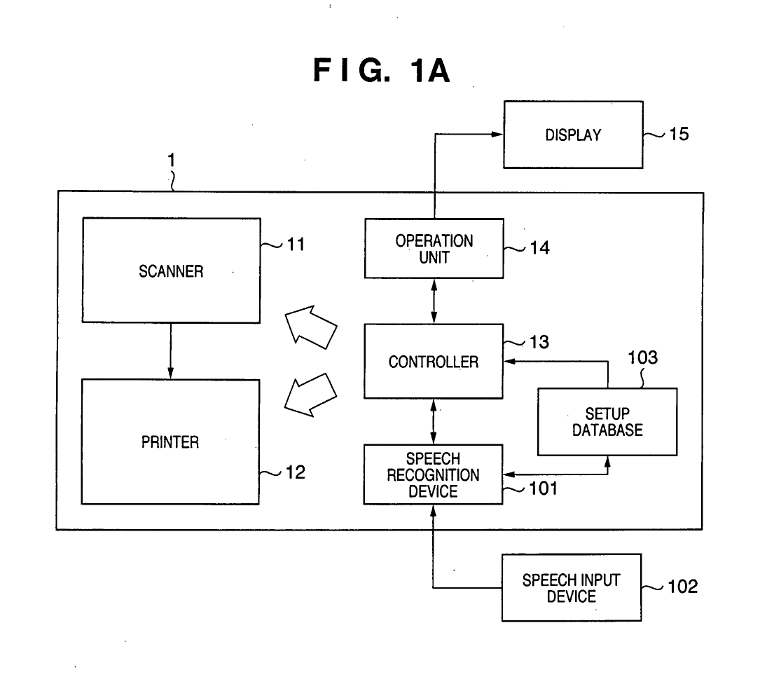

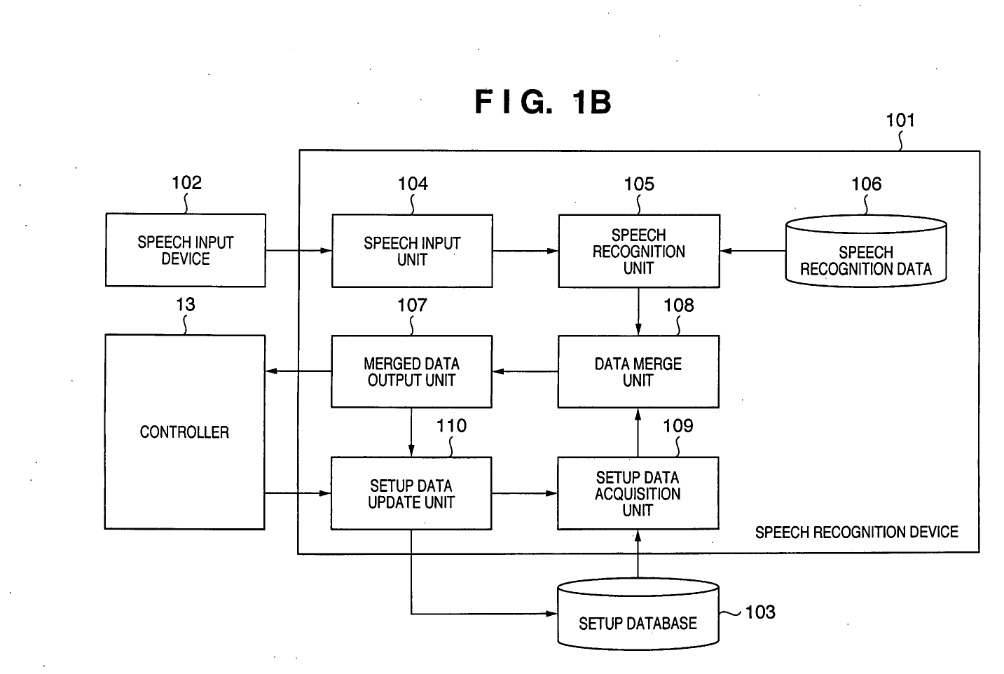

FIG. 1A is a block diagram showing the schematic construction of a copier according to a first embodiment. In FIG. 1A, reference numeral 1 denotes a copier. The copier 1 has a scanner 11 which optically reads an original image and generates an image signal and a printer 12 which print-outputs the image signal obtained by the scanner 11. The scanner 11 and the printer 12 realize a copying function, but there is no particular limitation of the constituent elements, and well-known scanner and printer are employed.

A controller 13, having a CPU, a memory and the like, controls the entire copier 1. An operation unit 14 provides a user interface realizing a user's various settings with respect to the copier 1. Note that the operation unit 14 includes a display 15 thereby realizes a touch panel function. A speech recognition device 101, a speech input device (microphone) 102 and a setup database 103 will be described later with reference to FIG. 1B. In this construction, the controller 13, the operation unit 14 and the speech recognition device 101, in cooperation with each other, realize the setting operation by speech in the copier.

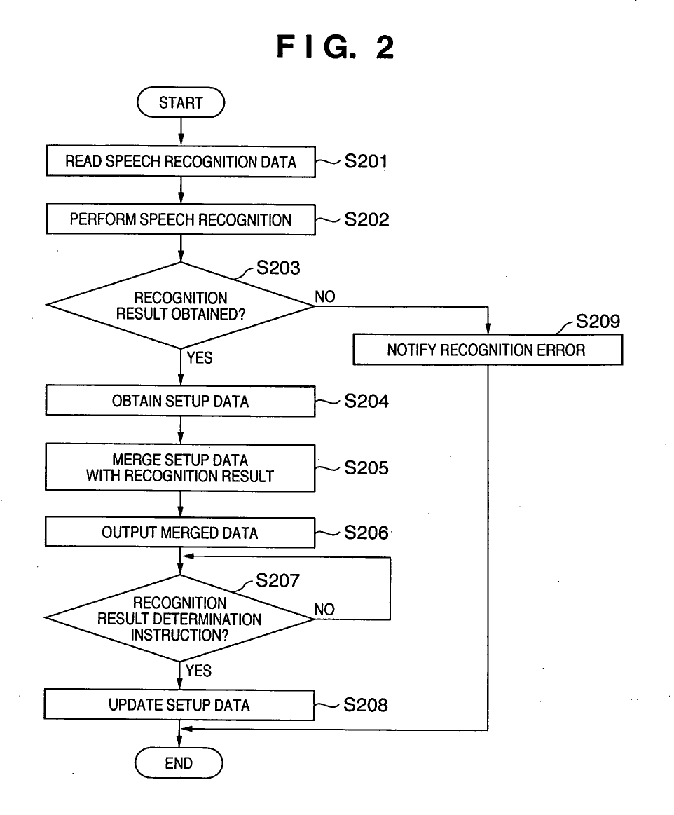

FIG. 1B is a block diagram showing the functional construction of the speech recognition device 101 according to the present embodiment. Note that it may be arranged such that a part or entire speech recognition device 101 is realized with the controller 13. FIG. 2 is a flowchart showing processing by the speech recognition device 101. In the following description, the setting of the copier 1 is performed using a speech UI and a GUI.

The speech input device 102 such as a desktop microphone or a hand set microphone to input a speech is connected to the speech recognition device 101. Further, the setup database 103 holding data set by the user in the past is connected to the speech recognition device 101. Hereinbelow, the functions and constructions of the respective elements will be described in detail in accordance with the processing shown in FIG. 2.

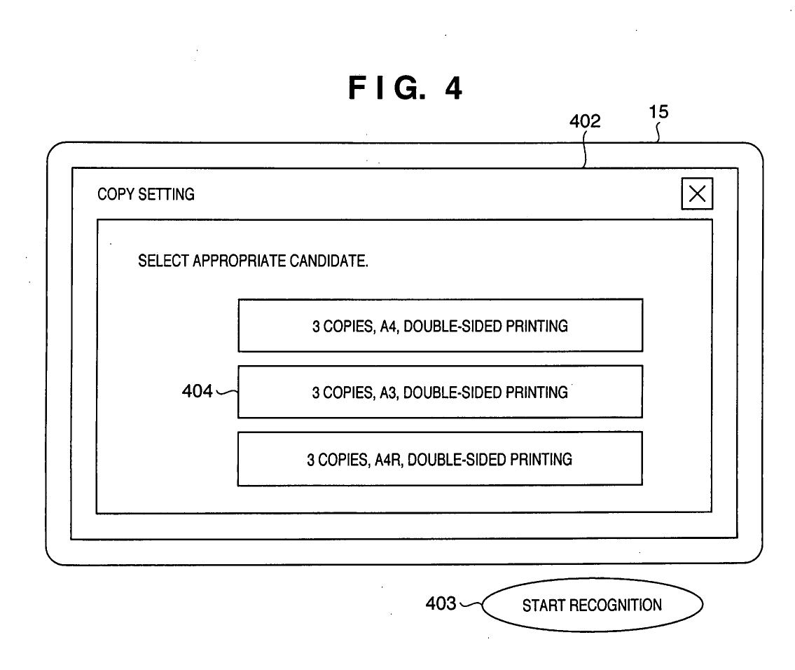

When a speech recognition processing start event has occurred with respect to the speech recognition device 101, the processing shown in FIG. 2 is started. Note that the speech recognition processing start event is produced by the user or a management module (controller 13) other than the speech recognition device 101 which manages dialogs. For example, as shown in FIG. 4, a speech recognition start key 403 is provided in the operation unit 14, and the controller 13 produces the speech recognition processing start event with respect to the speech recognition device 101 in correspondence with depression of the speech recognition start key 403.

When the speech recognition processing has been started, then at step S201, a speech recognition unit 105 reads speech recognition data 106 and performs initialization of speech recognition processing. The speech recognition data is various data used in the speech recognition processing. The speech recognition data includes speech recognition grammar describing linguistic limitations vocable for the user, and an acoustic model holding speech characteristic amounts.

Next, at step S202, the speech recognition unit 105 performs speech recognition processing on speech data inputted via the speech input device 102 and a speech input unit 104 using the speech recognition data read at step S201. Since the speech recognition processing itself is realized with a well-known technique, the explanation of the processing will be omitted here. When the speech recognition processing has been completed, then at step S203, it is determined whether or not a recognition result has been obtained. In the speech recognition processing, a recognition result is not always obtained. When utterance by a user is far different from the speech recognition grammar or the utterance by the user has not been detected for some reason, a recognition result is not outputted. In such case, the process proceeds from step S203 to step S209, at which the external management module is informed that a recognition result has not been obtained.

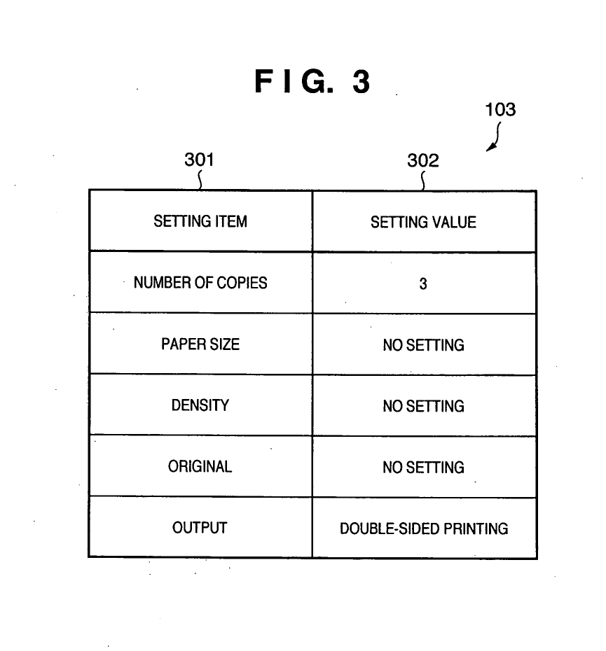

On the other hand, when a speech recognition result has been obtained by the speech recognition unit 105, the process proceeds from step S203 to step S204. At step S204, a setup data acquisition unit 109 obtains setup data from the setup database 103. The setup database 103 holds settings made by the user by that time for some task (e.g., a task to perform copying with the user's preferred setup). For example, assuming that the user is to duplicate an original with settings “3 copies” (number of copies), “A4-sized” (paper size) and “double-sided output” (output), and the settings of “number of copies” and “output” have been made, the information stored in the setup database 103 at this time is as shown in FIG. 3.

In FIG. 3, the respective items in the left side column are setting items 301, and the respective items in the right side column are particular setting values 302 set by the user. Regarding a setting item which the user has not been set, a setting value “no setting” is stored. Note that in the copier of the present embodiment, when a reset key provided in the copier main body is depressed, the contents of the setup database 103 can be cleared (the value “no setting” are stored as all the setting items).

Note that the setup database 103 holds data set by speech input, GUI operation and the like. In the right side column of the setup database 103, a setting item 302 having a value “no setting” indicates that setting has not been made. In this “no setting” item, a default value (or status set at that time such as previous setting value) managed by the controller 13 is set. That is, when the setup data is as shown in FIG. 3, the setting values managed by the controller 13 are set as the “no setting” items, and display on the operation unit 14 and a copying operation are performed.

When the setup data has been obtained from the setup database 103 at step S204, the process proceeds to step S205. At step S205, a speech recognition result/setup data merge unit (hereinafter, data merge unit) 108 merges the speech recognition result obtained by the speech recognition unit 105 with the setup data obtained by the setup data acquisition unit 109. For example, as the speech recognition result, the following three candidates are obtained.

First place: A4 [paper size]

Second place: A3 [paper size]

Third place: A4R [paper size]

Note that in the speech recognition processing, since N higher-rank results with high certainty can be outputted, plural recognition results are obtained here. The words in parentheses ([ ]) represent semantic interpretation of the recognition results. In the present embodiment, the semantic interpretation is the name of setting item in which the words can be inputted. Note that it is apparent for those skilled in the art that the name of setting item (semantic interpretation) can be determined from the recognition result. (For more information of the explanation of the semantic interpretation, see “Semantic Interpretation for Speech Recognition (http://www.w3.org/TR/semantic-interpretation/)” standardized by W3C.)

The merging of the speech recognition result with the setup data (by the data merge unit 108) at step S205 can be performed by substituting the speech recognition result into the setup data obtained at step S204. For example, assuming that the recognition result is as described above and the setup data is as shown in FIG. 3, since the first place speech recognition result is “A4 [paper size]”, setup data obtained by substituting “A4” into the setting value of “paper size” in the setup data in FIG. 3, is the merged data from the first place speech recognition result. Similarly, the merged data from the second place and third place speech recognition results can be generated.

At the next step S206, a merged data output unit 107 outputs the merged data generated as above to the controller 13. The controller 13 provides a UI for checking speech recognition (selection and determination of recognition result candidate) using the merged data, with the display 15. The presentation of merged data can be made in various forms. For example, it may be arranged such that a list of setting items and setting values as shown in FIG. 3 is displayed, and regarding the “paper size” as the recognition result in this example, the first to third candidates are enumerated. Further, regarding the “paper size” as the recognition result in this example, the information may be displayed with bold-faced type such that it can be distinguished from the other set items. The user can select a desired recognition result candidate from the presentation of recognition results.

Further, the merged data can be obtained by other methods than replacement of a part of setup data with speech recognition result as described above. For example, text information connected with only a setting value which is not a default value (“not setting” in FIG. 3), among the data where a part of setup data has been replaced with recognition result, may be obtained as merged data. In this method, in the above example, the first place recognition-result merged data is text data “three copies, A4, double-sided output”. FIG. 4 illustrates a display example of a check screen showing a speech recognition result using such text data.

FIG. 4 shows an example of the display of the speech recognition result by the copier 1 having the speech recognition device 101 as described above. The display 15, having a touch panel, displays the merged data outputted from the speech recognition device 101 in the form of text (404). When plural recognition results have been obtained by the speech recognition processing, the user can select merged data including a preferred speech recognition result (candidate) via the touch panel or the like. Further, even when there is only one recognition result candidate, the user can determine the recognition result via the touch panel.

When the speech recognition result has been selected via the touch panel as described above, a selection instruction is sent from the controller 13 to a setup data update unit 110. In the processing shown in FIG. 2, at step S207, in accordance with a recognition result determination instruction (a candidate selected and determined by the user from one or plural recognition result candidates), the process proceeds to step S208. At step S208, the setup data update unit 110 updates the setup database 103 with the “setting values” newly determined by the current speech recognition, in correspondence with the selected recognition result candidate. For example, when “A4” has been determined by the current speech recognition processing and determination operation, “no setting” in the item of paper size in the setup database 103 shown in FIG. 3 is updated to “A4”. Thus, when speech input has been made next, the contents of the updated setup database 103 are referred to, and the contents set by speech input by that time are merged with new speech recognition result, and a speech recognition result check screen is generated.

As describe above, according to the first embodiment, in the presentation for checking of speech recognition result, in addition to information corresponding to the content of utterance immediately previously produced by the user, information including the setting information set by the user by that time can be presented. This prevents the user's misconstruction that the values set by that time have been cleared.

### Second Embodiment

In the first embodiment, the merged data to be outputted is text data. However, the form of output is not limited to such text form. For example, the recognition result may be presented to the user in the form of speech. In this case, speech data is generated by speech synthesis processing from the merged data. The speech data synthesis processing may be performed by the data merge unit 108, the merged data output unit 107 or the controller 13.

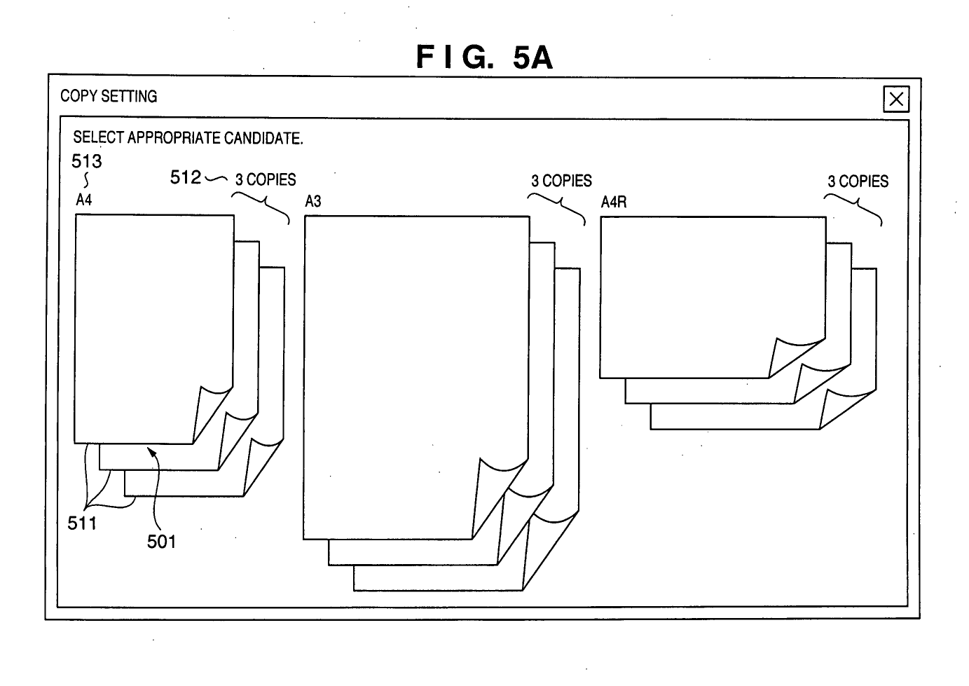

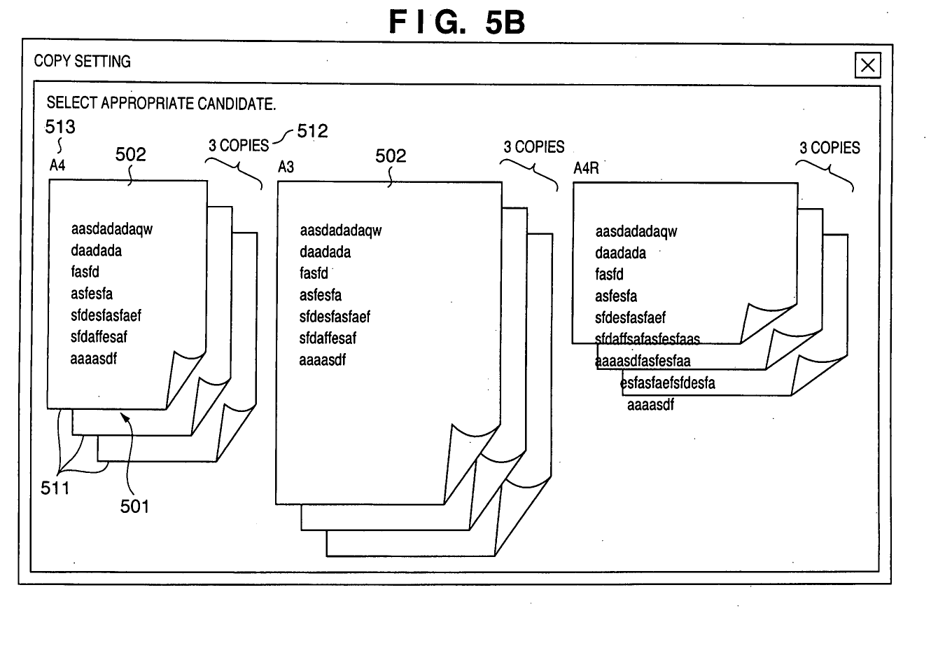

Further, the form of presentation of recognition result may be image data based on the merged data. For example, it may be arranged such that icons corresponding to the setting items are prepared, then, upon generation of image data, an icon specified from the setup data and a setting value as a recognition result is generated. For example, as shown in FIG. 5A, an image in the left part of the figure (merged data 501) is generated from the setup data “3 copies, double-side output” and the recognition result candidate “A4”. Numeral 511 denotes an icon corresponding to A4-size double-sided output, and the icon is overlay-combined by the designated number of copies (“3” in this example) and displayed. Numeral 512 denotes a display of numerical value of the number of copies, and numeral 513, a character display of size. The user can more clearly recognize the contents of the setup and the recognition result with these displays. Note that in FIG. 5A, similar image combining is performed regarding recognition result candidates A3 and A4R. The image data generation processing may be performed by the data merge unit 108, the merged data output unit 107 or the controller 13.

### Third Embodiment

Further, the data stored in the setup database 103 is not limited to the data dialogically set by the user. In the case of the copier 1, it may be arranged such that when the user has placed the original on the platen of the scanner 11 or a document feeder, the first page or all the pages of the original are scanned, then the obtained image data is stored into the setup database 103 in the form of JPEG or bitmap (***.jpg or ***.bmp). Then, the image data obtained by scanning the original as above may be registered as a setting value of e.g. the setting item “original” of the setup database 103 in FIG. 3. In this case, the controller 13 reads the first page of the original placed on the platen of the scanner 11 or the document feeder then stores the original image data as a setting value of the setting item “original” of the setup database 103. At this time, the image may be reduced and held as a thumbnail image as described later. Note that it may be arranged such that the size or type of original is determined by scanning the original and the result of determination is reflected as a setting value.

As described above, as the scan image is registered in the setup database 103, the data merge unit 108 can generate merged data using the image. FIG. 5B illustrates an example of display of the merged data using the scan image. In this example, the original is an A4 document in portrait orientation, and its scan image is reduced and used as an original document thumbnail image 502 of respective merged data 501. That is, the thumbnail image 502 is combined on the icon 511 corresponding to the “A4” size “double-sided output”, and overlaid by the set number of copies (3 copies) as shown in FIG. 5B. Images are similarly generated regarding the candidates A3 and A4R.

In the above arrangement, the user can intuitively understand the speech recognition result and setting status.

### Fourth Embodiment

In the fourth embodiment, in addition to the third embodiment, the ratios of paper size for merged data and size of thumbnail image to be presented as images are accurately outputted. In this arrangement, the interface for checking speech recognition result can also be utilized for checking whether or not the output format to be set is appropriate. An image corresponding to A4 double-sided output, A3 double-sided output or the like is obtained by reducing actual A4-sized or A3-sized image under a predetermined magnification. Further, the thumbnail image generated from the scan image is also obtained by reduction under the same predetermined magnification.

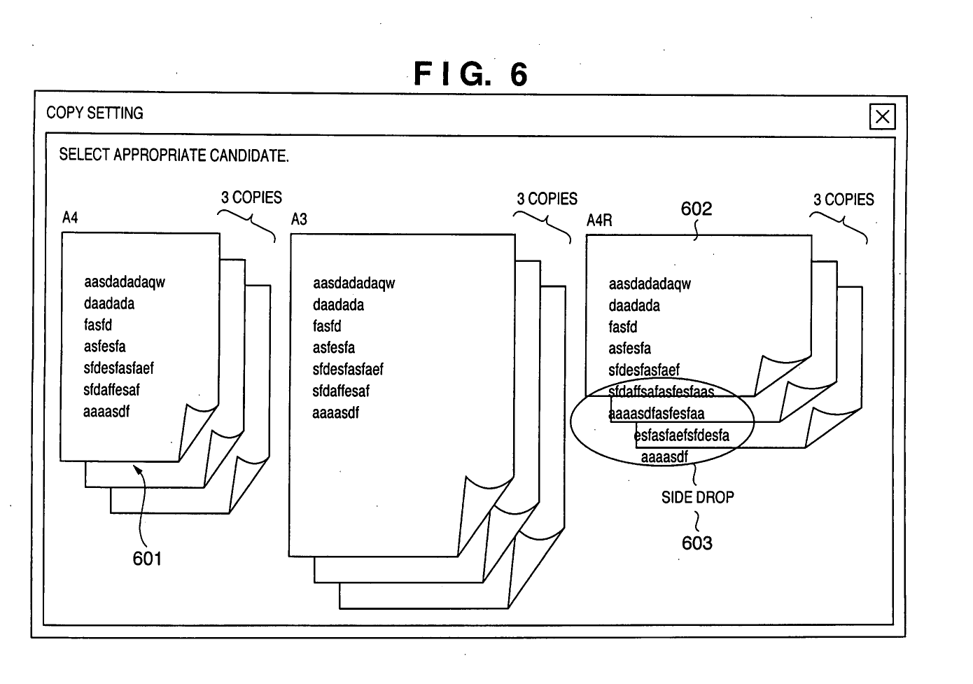

In FIG. 6, numeral 601 denotes an image display of merged data obtained by merging with accurate ratios of respective image elements as described above. In this example, inappropriate data can be automatically detected from the merged data. Numeral 602 denotes merged data when the current original (A4, portrait) is to be outputted on A4R paper. In this case, as the thumbnail image of the original runs over the output paper, there is a probability that a part of the original is missed in an output image. When such problem is detected upon generation of merged data by the data merge unit 108, a reason 603 of inappropriate output is applied. Further, the display of the merged data is changed so as to be distinguished from the other merged data by e.g. changing the color of the entire merged data.

Note that in the third and fourth embodiments, the original image is read and the obtained image is reduced, however, it may be arranged such that the size of the original is detected on the platen and the detected size is used. For example, when it is detected that the original is an A4 document in portrait orientation, “detection size A4 portrait” is registered as a setting value of the setting item “original” of the setup database 103. Then, upon generation of images as shown in FIGS. 5B and 6, a frame corresponding to the size A4 is used in place of the above-described thumbnail image (reduced image).

Further, in the above embodiment, the thumbnail of the original image is combined with an image of paper indicating double-sided output, and is overlaid by the designated number of copies, however, it may be arranged such that the thumbnail image of the original is combined with only the top paper image.

In the above arrangement, upon selection of speech recognition result, the user can intuitively know a recognition result candidate to cause a problem when selected.

### Fifth Embodiment

Further, when the data merge unit 108 merges the setup data with the speech recognition result, the merging may be performed such that the data previously stored in the setup database 103 can be distinguished from the data obtained by the current speech recognition. For example, FIG. 5A shows an example of display where the speech recognition results,

First place: A4 [paper size]

Second place: A3 [paper size]

Third place: A4R [paper size] are merged as image data with the data in the setup database in FIG. 3.

At this time, the merging is performed such that the setting values “3 copies” and “double-sided output” based on the contents of the setup database 103 can be distinguished from the setting value candidates “A4”, “A3” and “A4R” based on the speech recognition results. For example, a portion 513 indicating “A4”, “A3” and “A4R” of the respective merged data may be blinked. Further, the portion 513 may be outputted in a bold line (font).

Further, when the merged data is outputted using speech synthesis, the distinction may be made by changing a synthesized speaker upon data output based on the speech recognition result. For example, “3 copies” and “double-sided output” may be outputted in a female synthesized voice and “A4” may be outputted in a male synthesized voice.

In the above arrangement, the user can immediately distinguish the portion of current speech recognition result in the merged data. Accordingly, even when plural merged data are presented, a comparison among the portions of speech recognition results can be easily performed.

As described above, according to the respective embodiments, upon presentation of speech recognition result, a setting value set by the user's previous setting can be reflected in the speech recognition result. Accordingly, the contents of previous settings can be grasped upon checking of the speech recognition result, and the operability can be improved.

### Other Embodiment

Note that the object of the present invention can also be achieved by providing a storage medium holding software program code for realizing the functions of the above-described embodiments to a system or an apparatus, reading the program code with a computer (or a CPU or MPU) of the system or apparatus from the storage medium, then executing the program.

In this case, the program code read from the storage medium realizes the functions of the embodiments, and the storage medium holding the program code constitutes the invention.

Further, the storage medium, such as a flexible disk, a hard disk, an optical disk, a magneto-optical disk, a CD-ROM, a CD-R, a DVD, a magnetic tape, a non-volatile type memory card, and a ROM can be used for providing the program code.

Furthermore, besides aforesaid functions of the above embodiments are realized by executing the program code which is read by a computer, the present invention includes a case where an OS (operating system) or the like working on the computer performs a part or entire actual processing in accordance with designations of the program code and realizes functions of the above embodiments.

Furthermore, the present invention also includes a case where, after the program code read from the storage medium is written in a function expansion card which is inserted into the computer or in a memory provided in a function expansion unit which is connected to the computer, a CPU or the like contained in the function expansion card or unit performs a part or entire process in accordance with designations of the program code and realizes functions of the above embodiments.

As described above, according to the present invention, a user interface using speech recognition with high operability can be provided.

As many apparently widely different embodiments of the present invention can be made without departing from the spirit and scope thereof, it is to be understood that the invention is not limited to the specific embodiments thereof except as defined in the appended claims.

This application claims the benefit of Japanese Patent Application No. 2005-188317 filed on Jun. 28, 2005, which is hereby incorporated by reference herein in its entirety.

What is claimed is:

1. A user interface control method for controlling a user interface capable of setting contents of plural setting items using a speech, comprising:
a speech recognition step of performing speech recognition processing on an input speech;
an acquisition step of acquiring setup data indicating the content of already-set setting item from a memory;
a merge step of merging a recognition result obtained at said speech recognition step with the setup data acquired at said acquisition step thereby generating merged data;
an output step of outputting said merged data for a user's recognition result determination operation; and
an update step of updating said setup data in correspondence with said recognition result determination operation.

2. The method according to claim 1, wherein the merged data generated at said merge step includes text information.

3. The method according to claim 2, further comprising a speech synthesis step of converting said text information into a speech.

4. The method according to claim 1, wherein the merged data generated at said merge step includes image information indicating said setup data and said recognition result.

5. The method according to claim 1, further comprising a presentation step of presenting said merged data outputted at said output step to the user,
wherein at said presentation step, the speech recognition result obtained at said speech recognition step and the setup data acquired at said acquisition step are presented distinguishably from each other.

6. The method according to claim 1, wherein said plural setting items relate to original copying processing,
and wherein the merged data generated at said merge step includes said setup data, image information indicating said recognition result and original image information obtained by reading said original.

7. The method according to claim 1, further comprising:
a determination step of determining whether or not said merged data includes an inappropriate setting; and
a presentation step of presenting said merged data outputted at said output step to the user,
wherein at said presentation step, said merged data, determined at said determination step that it includes an inappropriate setting, is presented as an inappropriate setting.

8. The method according to claim 7, wherein said plural setting items relate to original copying processing,
and wherein at said determination step, matching between the size of said original and selected paper is determined.

9. A user interface apparatus capable of setting contents of plural setting items using a speech, comprising:
a speech recognition unit adapted to perform speech recognition processing on an input speech;
an acquisition unit adapted to acquire setup data indicating the content of already-set setting item from a memory;
a merge unit adapted to merge a recognition result obtained by said speech recognition unit with the setup data acquired by said acquisition unit thereby generating merged data;
an output unit adapted to output said merged data for a user's recognition result determination operation; and
an update unit adapted to update said setup data in correspondence with said recognition result determination operation.

10. The apparatus according to claim 9, wherein the merged data generated by said merge unit includes text information.

11. The apparatus according to claim 9, further comprising a speech synthesis unit adapted to convert said text information into a speech.

12. The apparatus according to claim 9, wherein the merged data generated by said merge unit includes image information indicating said setup data and said recognition result.

13. The apparatus according to claim 9, further comprising a presentation unit adapted to present said merged data outputted by said output unit to the user,
wherein said presentation unit presents the recognition result obtained by said speech recognition unit and the setup data acquired by said acquisition unit distinguishably from each other.

14. The apparatus according to claim 9, wherein said plural setting items relate to original copying processing,
and wherein the merged data generated by said merge unit includes said setup data, image information indicating said recognition result and original image information obtained by reading said original.

15. The apparatus according to claim 9, further comprising:
a determination unit adapted to determine whether or not said merged data includes an inappropriate setting; and
a presentation unit adapted to present said merged data outputted by said output unit to the user,
wherein said presentation unit presents said merged data, determined by said determination unit that it includes an inappropriate setting, as an inappropriate setting.

16. The apparatus according to claim 15, wherein said plural setting items relate to original copying processing,
and wherein said determination unit determines matching between the size of said original and selected paper.

17. A control program for performing the user interface control method in claim 1 with a computer.
